(19) United States
(12) Patent Application Publication
(10) Pub. No.: US 2015/0175876 A1
(43) Pub. Date: Jun. 25, 2015

(54) METHOD AND FOAM COMPOSITION FOR RECOVERING HYDROCARBONS FROM A SUBTERRANEAN RESERVOIR

(71) Applicant: THE BOARD OF REGENTS OF THE UNIVERSITY OF OKLAHOMA, Norman, OK (US)

(72) Inventors: Daniel E. Resasco, Norman, OK (US); Santiago Drexler, Rio De Janeiro (BR); Jeffrey H. Harwell, Norman, OK (US); Bor Jier Shiau, Norman, OK (US); Mohannad J. Kadhum, Norman, OK (US); Jimmy Faria, Norman, OK (US); M. Pilar Ruiz, Seville (ES)

(21) Appl. No.: 14/344,241

(22) PCT Filed: Sep. 28, 2012
(86) PCT No.: PCT/US2012/057733

§ 371 Date: Mar. 11, 2014

Related U.S. Application Data
(60) Provisional application No. 61/542,521, filed on Oct. 3, 2011.

(51) Int. Cl. C09K 8/594; E21B 43/16

(52) U.S. Cl. CPC C09K 8/594; E21B 43/166; C09K 2208/10

(57) ABSTRACT

Enhanced recovery of hydrocarbons from a subterranean reservoir injects a gaseous reactant and a dispersion of oil, water, and nano-hybrid catalysts through an injection well into a subterranean formation. The combination of the dispersion and gaseous reactant(s) forms a stabilized foam within the subterranean formation. When the foam reaches an oil-water inter-face, the nanohybrid catalysts catalytically partially oxidize the hydrocarbons present at the oil-water interface thereby increasing the capillary number and decreasing the interfacial tension at the oil-water interface.

### PRIORITY CLAIM

This application claims priority to U.S. Provisional Application Ser. No. 61/542,521, filed on Oct. 3, 2011, the entirety of which is incorporated herein by reference.

### BACKGROUND

The production of oil from subterranean reservoirs typically follows a pattern of primary production followed by the use of secondary and tertiary recovery techniques to recover entrained hydrocarbons. Secondary and tertiary recovery techniques generally rely upon artificial lift systems and methods which reduce the viscosity of the entrained oil by injecting a diluting agent such as water, steam or carbon dioxide. These enhanced oil recovery techniques extend the life of the reservoir thereby reducing the need for additional drilling operations. As energy demands continue to grow, the oil industry continues to seek out improved enhanced recovery methods.

### SUMMARY

Embodiments of the present invention provide for enhanced recovery of hydrocarbons from a subterranean reservoir. Embodiments of the present invention may be combined with any existing secondary and tertiary techniques or may be used solely as the preferred secondary or tertiary recovery process.

Embodiments of the present invention inject a dispersion and gaseous reactant through an injection well into the subterranean formation to form a foam. The dispersion may comprise oil, water, and nanoparticles (e.g., nanohybrid catalysts). Suitable nanoparticles may include single wall carbon nanotubes, multiwall carbon nanotubes, graphitic nano-platelets and Janus amphiphilic particles. The nanoparticles may carry a catalytic metal or metal oxide suitable for partially oxidizing organic compounds. Hereinafter, the foregoing functionalized nanoparticles are also referred to as “nanohybrid catalysts.” The gaseous reactants may include hydrogen, air, carbon monoxide, oxygen, nitrogen oxide, vaporized hydrogen peroxide, hydrazine, and ammonia. A combination of the dispersion and gaseous reactant(s) forms a stabilized foam within the subterranean formation. The resulting foam moves through the formation to an oil-water interface located within the subterranean production zone. Upon delivery of the stabilized foam to the oil-water interface, the foam destabilizes and delivers the nanohybrid catalysts to the oil-water interface. Subsequently, the nanohybrid catalysts catalytically partially oxidize the hydrocarbons present at the oil-water interface thereby increasing the capillary number and decreasing the interfacial tension at the oil-water interface. The alteration in capillary number and the interfacial tension enhance subsequent recovery of the partially oxidized hydrocarbon from the subterranean formation.

### BRIEF DESCRIPTION OF THE DRAWINGS

FIG. 1 depicts a subterranean reservoir with an injection well, a production zone and a production well.

FIG. 2 shows a flow diagram of a method for enhancing recovery of hydrocarbons from a subterranean reservoir using in situ formation of a foam stabilized by catalytic particles.

### DETAILED DESCRIPTION

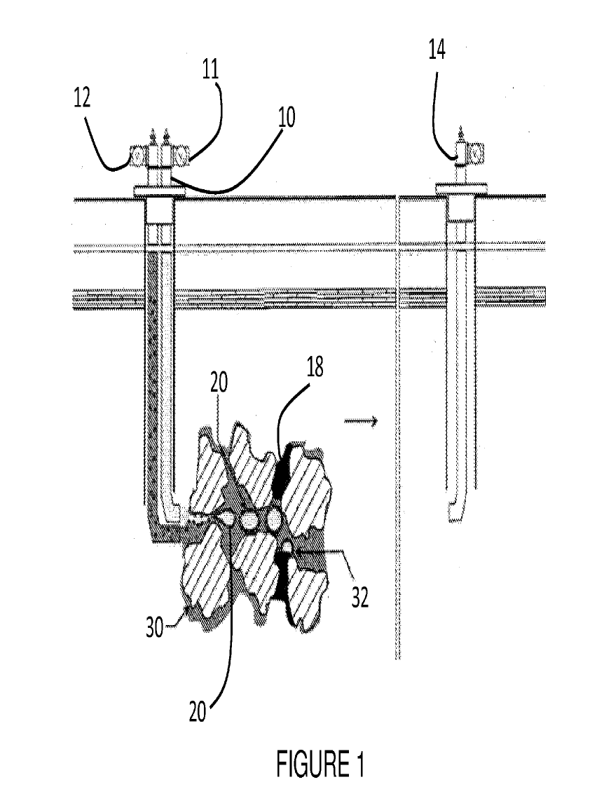

Embodiments of the present invention enhance the recovery of hydrocarbons from a subterranean formation through the in situ formation of a stabilized foam. With reference to FIG. 1, embodiments of the present invention inject a dispersion component and a gas component through an injection well 10 into the downhole environment. Such injections of the components may be performed substantially simultaneously. The injected components form a stabilized foam 20 configured for transitioning through the subterranean formation 30.

Turning to the components used to prepare the stabilized foam, the dispersion may contain water, nanoparticles, and/or other modifying agents selected for the targeted downhole environment. Suitable modifying agents may be interfacial-active agents such as, but not limited to, alkyl sulfates, alkyl ether sulfates, sulfonate fluorosurfactants, alkyl benzene sulfonates, alkyl aryl ether phosphates, alkyl ether phosphates, alkyl carboxylates, carboxylate fluorosurfactants, alkyltrimethylammonium salts, zwitterionic salts, amino acids, imino acids, betaines, polyoxyethylene glycol alkyl ethers, polyoxypropylene glycol alkyl ethers, glucoside alkyl ethers, polyoxyethylene glycol alkylphenol ethers, glycerol alkyl esters, polyacrylamide, polyvinylpyrrolidone, polyoxyethylene glycol sorbitan alkyl esters, polysorbates, sorbitan alkyl esters, block copolymers of polyethylene glycol and polypropylene glycol, and/or combinations of thereof.

The nanoparticles may provide at least two functions within the foam. First, the nanoparticles have a structure that stabilizes the foam. Second, the nanoparticles may carry catalysts suitable for inducing oxygenation and/or hydrogenation reactions of the hydrocarbons located in the subterranean reservoir thereby producing more readily extractible compounds.

Such nanoparticles, also referred to herein as nanohybrid catalysts, may have a hydrophilic component and a hydrophobic component. The hydrophobic component may be a carbon-based component, such as single wall nanotubes or multi-wall carbon nanotubes. Other suitable carbon-based components include, but are not limited to, “onion-like” carbon structures (e.g., graphitic nano-platelets), carbon nanofibers, and amorphous carbon (e.g., soot). The particle sizes of the nanohybrid catalysts may be from approximately 10 nm to approximately 2000 nm, in order to produce stable foams.

The hydrophobic component may be fused or carried by the hydrophilic component. Hydrophilic components include, but are not limited to, SiO₂, Al₂O₃, MgO, ZnO, TiO₂, Nb₂O₅, Al(OH)₃, V₂O₅, Cr₂O₃, MnO₂, Fe₂O₃, FeO, Fe₃O₄, CoO, ZnO, Y₂O₃, ZrO₂, Nb₂O₅, CdO, La₂O₃, SnO₂, HfO₂, Ta₂O₅, WO₃, Re₂O₇, CeO₂, Cs₂O, Hydrotalcite, zeolites, and mixtures thereof.

The catalyst portion may be a metal or metal oxide selected for its ability to catalytically oxygenate or hydrogenate hydrocarbon compounds commonly found in subterranean reservoirs. The catalytic component may be carried on either the hydrophobic or hydrophilic portion. Catalytic materials may include metals such as, but not limited to: Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, and Au. Additionally, metal oxides may be incorporated as catalytic material. Suitable metal oxides include but are not limited to: TiO₂, V₂O₅, Cr₂O₃, MnO₂, Fe₂O₃, FeO, CoO, ZnO, Y₂O₃, ZrO₂, Nb₂O₅, CdO, La₂O₃, SnO₂, HfO₂, Ta₂O₅, WO₃, Re₂O₇, Al₂O₃, CeO₂, Cs₂O, and MgO.

In embodiments, for oxidation reactions, a nanohybrid catalyst may be a multi-wall carbon nanotube fused to alumina with a catalyst of copper on either the hydrophobic nanotubes or the hydrophilic silica depending on the anticipated downhole environment. In embodiments, for hydrogenation reactions, the nanohybrid catalyst may be a multi-wall carbon nanotube fused to alumina with a catalyst component selected from Ni or Ni-Mo on either the hydrophobic nanotubes or the hydrophilic silica depending on the anticipated downhole environment. The catalyst component may be positioned on the hydrophobic portion of the nanohybrid to achieve greater exposure to the hydrocarbons within the subterranean formation.

The dispersion may have from approximately 0.05% to approximately 10% nanohybrid catalysts by weight. The ratio of oil to water within the dispersion may be approximately 1:1. However, the oil to water ratio may range from approximately 1:9 to 9:1.

Alternatively, Janus particles may be substituted for the nanoparticles of carbonaceous material and support. Janus particles are two-sided particles with one side being hydrophobic and the other side hydrophilic. Thus, an alternative nanohybrid is in the form of a Janus particle carrying the catalytic metal or metal oxide.

Foams include a gas phase and a liquid phase. In embodiments of the present invention, the dispersion described above is the liquid phase of the foam. The gas phase of the foam includes gases such as, but not limited to, hydrogen, air, carbon dioxide, carbon monoxide, oxygen, nitrogen oxide, vaporized hydrogen peroxide, hydrazine, ammonia, and mixtures thereof. The gas phase may be a gas selected for its ability to enhance the hydrogenation of the hydrocarbons present at an oil-water interface in the reservoir. For example, the gas for injection with the dispersion may be air for oxidation conditions and hydrogen for hydrogenation conditions.

To enhance the stability and mobility of the foams, the dispersion may also include stabilizers and modifiers suitable for tailoring the foam to the targeted subterranean reservoir. The dispersion must have sufficient stability to reach the target zone without loss of the nanohybrid material. To achieve this, the dispersion may utilize from approximately 100 ppm to approximately 2000 ppm multi-wall carbon nanotubes, from approximately 100 ppm to approximately 1000 ppm dispersion stabilizing polymer such as polyvinylpyrrolidone (“PVP”) in brine or water. The following discussion describes preparation of a stabilized dispersion.

In the following discussion, samples of dispersions were prepared and analyzed according to the following process (all parameters are approximate):
Generate a dispersion by adding the indicated amounts of MWCNT and PVP to either deionized water or brine.
Sonicate for approximately two hours to produce a dispersion.
Isolate a supernatant by centrifugation—the supernatant contains the stabilized nanohybrids dispersion.
Determine concentration of MWCNT in supernatant by comparing the absorbance of the supernatant to a calibration curve (such as the calibration curve shown in Table 1).

Tables 2-4 indicate an impact of nanohybrid concentration and centrifugation time on dispersion stability. Four samples were prepared with 1000 ppm PVP in DI water. Concentrations of MWCNT were 500 ppm, 1000 ppm, 2000 ppm, 5000 ppm. Following isolation of the supernatant, the samples were further centrifuged for 500, 1000, or 2000 rpm. Stability of the dispersion was determined by optically determining the loss of MWCNT at 10, 30 and 60 minutes at each centrifugation speed. The following tables provide the concentration of MWCNT following centrifugation and the percent loss of MWCNT. See Tables 2-4, where Tables 2A, 3A, and 4A reflect the concentration of MWCNT in the supernatant at 10, 30 and 60 minutes of centrifugation. Tables 2B, 3B, and 4B reflect the percent loss of MWCNT from the supernatant at each time interval. Based on percent loss following additional centrifugation, the dispersion initially containing 500 ppm MWCNT/alumina proved to be the most stable at each centrifugation speed.

Tables 5-9 indicate an impact of polymer concentration on dispersion stability. A series of samples were prepared to assess the impact of PVP concentration in brine on dispersion stability. Tables 5-7 report the change in ppm and percent loss of MWCNT in samples initially containing 2000 ppm MWCNT/alumina and 1000 or 5000 ppm PVP in a brine solution of 8% wt. NaCl and 2% wt CaCl₂. Tables 8-9 report the change in ppm and percent loss of MWCNT in samples initially containing 500 ppm MWCNT/alumina and 200, 2000 or 5000 ppm PVP in the same brine solution. Based on the results from both series of samples, PVP concentration provides some degree of dispersion stabilization at low centrifugation speed during the initial test period. Thus, the PVP primarily aids in the initial dispersion of MWCNT and only moderately impacts the stability of the resulting dispersion.

Since brine is a common downhole fluid, the impact of brine on dispersion stability should be known in order to provide a desired delivery of the nanohybrid material to the crude oil. Tables 10-12 indicate an impact of brine concentration on dispersion stability. Dispersions using 2000 ppm MWCNT/alumina and 1000 ppm PVP were prepared with DI water and brine. As reflected by Tables 10-12, the brine dispersion differed from the DI water dispersion at the lower centrifugation speed of 500 rpm. At higher rpm, the difference between brine and DI water was not significant. Thus, preparation of a dispersion using brine, a material compatible with most operating fluids, will not detrimentally impact the performance of embodiments of the present invention.

Additionally, the nature of the nanohybrid may determine the degree of dispersion stabilizers needed to maintain the dispersion. Therefore, Tables 13 and 14 compare dispersion stability using single wall carbon nanotubes to multi-wall carbon nanotubes. To determine the significance of the carbon nanotube material, samples were prepared using single wall carbon nanotubes on silica (SiO₂) in brine with PVP. Tables 13 and 14 compare the stability of a dispersion containing single wall carbon nanotubes to a dispersion using MWCNT. As reflected by the tables, use of single wall carbon nanotubes did not yield a dispersion. Rather, immediately after sonication, the single wall carbon nanotubes were observed to immediately begin settling out of solution. Following 10 minutes of centrifugation, no single wall carbon nanotubes remained in dispersion. Therefore, additional dispersion stabilizers may be required when using single wall carbon nanotubes.

Tables 15A and 15B demonstrate the ability of purified multi-wall carbon nanotubes (MWCNT) to increase foam stability based on a comparison of the volume of the resulting foam when prepared in brine and de-ionized water solutions over a period of time.
Foams were generated in de-ionized water using the following formulations:
Sample 1 (S1 in Table 15A)—100 ppm MWCNT, 100 ppm polyvinyl pyrrolidone (PVP) and 4000 ppm hydroxyethyl cellulose (HEC-10, a common drilling fluid viscosifier/fluid loss control agent);
Sample 2 (S2 in Table 15A)—4000 ppm sodium dodecyl benzene sulfate (SDBS);
Sample 3 (S3 in Table 15A)—4000 ppm HEC-10.

Foams were generated in 10% API brine using the following formulations:
Sample 4 (S4 in Table 15B)—4000 ppm HEC-10;
Sample 5 (S5 in Table 15B)—100 ppm MWCNT, 100 ppm PVP, 4000 ppm SDBS and 4000 ppm HEC-10;
Sample 6 (S6 in Table 15B)—100 ppm MWCNT, 100 ppm PVP and 4000 SDBS
Sample 7 (S7 in Table 15B)—100 ppm MWCNT and 4000 SDBS;
Sample 8 (S8 in Table 15B)—4000 ppm SDBS.

Tables 15A and 15B depict the volume of foam per total volume of solution (normalized volume) used to generate the foam as a function of time. Each foam was prepared in a Cole Parmer mixer operated at 2000 rpm for 5 minutes. As depicted in each Figure, foams containing purified MWCNT have an extended life. Specifically, samples S1, S5, S6 and S7, each having 100 ppm MWCNT provided significantly longer foam life when compared to foams lacking MWCNT.

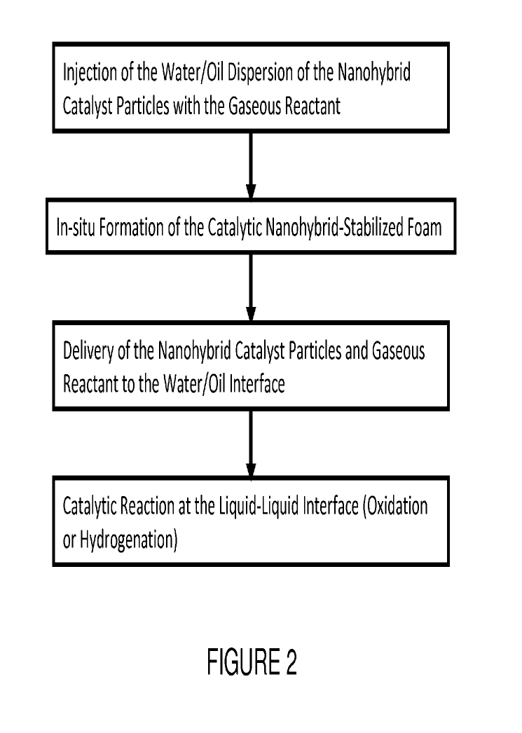

With continued reference to the above embodiments, the following discloses using the dispersion and gases disclosed herein to form a foam in situ, i.e., in the downhole environment 30. With reference to FIGS. 1 and 2, the foregoing dispersion and gaseous components may be injected downhole simultaneously (though they may be sequentially injected) through injection well ports 11 and 12; however, both components may also be injected through a single port. The injection rates generate sufficient shear to overcome the energetic barrier to forming a foam 20. Typically, the injection rate will be sufficient to generate shear rates between approximately 10³ and approximately 10⁴ sec⁻¹.

During foam formation within the injection well and subterranean formation 30, the nanohybrid catalyst particles will align at the resulting gas-liquid interface with the hydrophobic component of the particles extending into the gas phase and the hydrophilic component extending into the liquid phase. This orientation of the particles at the gas-liquid interface stabilizes the foam.

Following foam formation, either naturally occurring formation flow or enhanced flow provided by injection of fluids through injection well 10 and production of fluids through production well 14 will drive the resulting foam 20 to the desired location(s) within subterranean formation 30. Upon delivery of the foam 20 to the oil-water interface(s) 32, the foam 20 destabilizes delivering the catalyst and the gas phase reactants to the oil-water interface(s) 32. Upon elimination of the foam's gas-liquid interface, a “new gas-water-oil interface” will form with the solid nanohybrid catalysts adsorbed at the interface. The type of hydrocarbons present within subterranean formation 30 and the nature of the catalysts and reactive gases will dictate the initial reactions. As noted above, the dispersion formulation will vary from formation to formation as needed to maximize, or at least enhance, production from the subterranean formation.

Improvement in hydrocarbon production during secondary and tertiary recovery processes may require an increase in the capillary number (Nc) and lowering of the Mobility Ratio (MR). The capillary number Nc=vμ/σ, where v is the Darcy velocity (through the pore), μ the viscosity of the mobilizing fluid (water), and σ the interfacial tension (IFT) between the oil and the water. Typical values of Nc after water flooding are around 10⁻⁷. An increase of two orders of magnitude may be needed to improve oil recovery. The Mobility Ratio (MR=(k_{w}/kₒ)/(μ_{w}/μₒ)) is a function of the relative permeability (kᵢ) of the porous media towards oil and water, respectively, and the viscosity (μᵢ) of the oil and the mobilizing fluid (water), respectively. As used in the Mobility Ratio formula, k_{w} is the water relative permeability, kₒ is the oil relative permeability, μ_{w} the sweeping fluid viscosity, and μₒ the oil viscosity. To achieve displacement of oil by water, the MR must be lower than the unity. To provide the desired condition, one increases the sweeping fluid's viscosity. Accordingly, a low value of μₒ/μ_{w} is favorable for oil displacement.

The catalytic partial oxidation of the subterranean hydrocarbons present at the “new gas-water-oil interface” will lower the water-oil interfacial tension leading to an increase in the capillary number. Additionally, partial hydrogenation by reaction of the gas component delivered as part of the stabilized foam will enhance the viscosity of the oil phase in the subsequently formed emulsion, thus improving the MR of the hydrocarbons within the subterranean reservoir. In addition, the partial hydrogenation of the hydrocarbons can be an effective pre-treatment favoring the subsequent catalytic partial oxidation. The extent of the hydrogenation reaction will be controlled by the concentration of the reducing agent in the reservoir.

Following formation of the “new gas-water-oil interface,” catalytic reactions will occur as dictated by the nature of the dispersion, the gaseous reactants, and the subterranean hydrocarbons.

The catalytic partial-oxidation of the hydrocarbons at the gas-water-oil interface will generate polar functional groups (e.g., —OH, —COOH, —CHO) on the hydrocarbons. As a result, the capillary number will increase and the interfacial tension will decrease. Due to the higher dipole moment of oxygenated compounds, increasing the concentration of oxygenated hydrocarbons has an exponential effect on the interfacial tension and facilitates the self-assembly of water-oil microemulsions in the subterranean formation.

The hydrogenation reaction of the residual crude oil 18 (see FIG. 1) at the oil-water interface(s) of the subterranean formation 20 increases the flexibility of the polyaromatic molecules present in heavy crude oils (10-16° API), decreasing the viscosity (μ) of the stationary fluid. Additionally, the hydrogenation improves the quality of the subterranean hydrocarbons by reducing the concentration of heavy polyaromatic molecules.

Thus, the catalytic reactions, will reduce the water-oil interfacial tension and increase the viscosity of the flooding fluid. As a result, the combination of oxidation and hydrogenation reactions will enhance the oil recovery by simultaneously increasing the capillary number and reducing the mobility ratio.

Following the catalytic reactions, the hydrocarbons 18 can be produced (e.g, by pumping action at the production well 14). However, injected fluids, such as water, steam, or carbon dioxide, may be used to enhance the movement of the resulting microemulsion to the production well 14. Alternatively, the in situ formed foam may also act as a sweeping agent driving the reacted hydrocarbons 18 to the production well 14.

Other embodiments of the present invention will be apparent to those skilled in the art from consideration of this specification or practice of the invention disclosed herein.

1. A method comprising:
injecting into a subterranean reservoir a dispersion comprising nanoparticles;
injecting a gaseous reactant into said subterranean reservoir;
a combination of the dispersion and gaseous reactant thereby forming a foam within said subterranean formation that is delivered to an oil-water interface within said subterranean reservoir where said foam destabilizes and delivers said nanoparticles to the oil-water interface;
said nanoparticles having a physical configuration for increasing a capillary number and decreasing an interfacial tension at the oil-water interface.

2. A method comprising:
injecting into a subterranean reservoir a dispersion comprising oil, water, and nanohybrid catalysts, said nanohybrid catalysts comprising nanoparticles selected from the group consisting of single wall carbon nanotubes, multiwall carbon nanotubes, onion-like carbon, and Janus amphiphilic particles, said nanohybrid catalysts functionalized to partially oxidize organic compounds;
injecting a gaseous reactant into said subterranean reservoir;
a combination of the dispersion and gaseous reactant thereby forming a stabilized foam within said subterranean formation that is delivered to an oil-water interface within said subterranean reservoir where said foam destabilizes and delivers said nanohybrid catalysts to the oil-water interface;
said nanohybrid catalysts catalytically partially oxidizing hydrocarbons present at said oil-water interface thereby increasing a capillary number and decreasing an interfacial tension at the oil-water interface.

3. (canceled)

4. (canceled)

5. The method of claim 1 wherein said nanoparticles are functionalized with a metal or metal oxide configured for partially oxidizing organic compounds.

6. Canceled.

7. The method of claim 5, wherein said nanoparticles have a hydrophobic carbonaceous structure, said hydrophobic carbonaceous structure carries said metal.

8. The method of claim 5, wherein said nanoparticles are carried by an oxide support selected from the group consisting of silica and alumina.

9. (canceled)

10. (canceled)

11. (canceled)

12. (canceled)

13. The method of claim 2, wherein the injections of the dispersion and gaseous reactant occur at flow rates sufficient to generate shear rates suitable for forming the foam.

14. The method of claim 1, wherein the injections of the dispersion and gaseous reactant produce shear rates between approximately 10³ and 10⁴ sec⁻¹.

15. The method of claim 1, wherein the partial oxidation of hydrocarbon present at said oil-water interface facilitates a self-assembling of water-oil microemulsions in said subterranean formation.

16. The method of claim 2, wherein said gaseous reactant is hydrogen which results in the nanohybrid catalysts catalytically hydrogenating hydrocarbons present in said subterranean formation.

17. The method of claim 16, wherein said hydrogenating occurs prior to the oxygenating.

18. The method of claim 1, wherein the injecting of the gaseous reactant into said subterranean reservoir occurs simultaneously with the injecting of said dispersion.

19. (canceled)

20. The method of claim 2, further comprising recovering the partially oxidized hydrocarbons from said subterranean formation.

21. The method of claim 20, wherein said injections occur through a single injection well and the recovery of hydrocarbons from said subterranean formation occurs through a separate production well.

22. (canceled)

23. The method of claim 21, further comprising maintaining a pressure differential between said injection well and said production well thereby driving said stabilized foam to said oil-water interface.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. The method of claim 2, wherein said nanohybrid catalysts are functionalized with a metal or metal oxide configured for partially oxidizing organic compounds.

47. The method of claim 46, wherein said nanohybrid catalysts have a hydrophobic carbonaceous structure, said hydrophobic carbonaceous structure carries said metal.

48. The method of claim 46, wherein said nanohybrid catalysts are carried by an oxide support selected from the group consisting of silica and alumina.

49. The method of claim 2, wherein the injections of the dispersion and gaseous reactant produce shear rates between approximately 10³ and 10⁴ sec⁻¹.

50. The method of claim 2, wherein the partial oxidation of hydrocarbon present at said oil-water interface facilitates a self-assembling of water-oil microemulsions in said subterranean formation.

51. The method of claim 2, wherein the injecting of the gaseous reactant into said subterranean reservoir occurs simultaneously with the injecting of said dispersion.
